(19) United States
(12) Patent Application Publication
(10) Pub. No.: US 2026/0067479 A1
(43) Pub. Date: Mar. 5, 2026

(54) FINE-TUNING A LIMITED SET OF PARAMETERS IN A DEEP CODING SYSTEM FOR IMAGES

(71) Applicant: InterDigital CE Patent Holdings, SAS, Paris (FR)

(72) Inventors: Francois Schnitzler, Saint Ave (FR); Muhammet Balcilar, Betton (FR); Anne Lambert, Saint-Aubin-d’Aubigné (FR); Oussama Jourairi, Rennes (FR)

(21) Appl. No.: 18/878,439

(22) PCT Filed: Jun. 23, 2023
(86) PCT No.: PCT/EP2023/067073

§ 371 Date: Dec. 23, 2024

(30) Foreign Application Priority Data
Jun. 30, 2022 (EP) 22305957.7

(51) Int. Cl. H04N 19/42; H04N 19/124; H04N 19/147; H04N 19/189

(52) U.S. Cl. CPC H04N 19/42; H04N 19/124; H04N 19/147; H04N 19/189

(57) ABSTRACT

A deep neural network-based coding system for images determines update parameters of a deep neural network model for decoding an image. The parameters are determined by an encoder and provided to a decoder to update the model of the decoder before decoding the image. This provides structural sparsity by fine-tuning only some parameters of the neural decoder. The update is done either on a set of predetermined parameters so that the structural sparsity is identical for all images or on a set of parameters selected based on the image to be encoded so that the structural sparsity is image specific. A new training procedure as well as an end-to-end trainable quantization are also proposed allowing to include trained parameters in a bitstream and to update parameters in the decoder.

### TECHNICAL FIELD

At least one of the present embodiments generally relates to neural network-based image compression and more particularly to the fine-tuning of parameters of a deep decoder.

### BACKGROUND

Image and video compression is a fundamental task in image processing, which has become crucial in the time of pandemic and increasing video streaming. Thanks to the community's huge efforts for decades, traditional methods have reached current state of the art rate-distortion performance and dominate current industrial codecs solutions. End-to-end trainable deep models have recently emerged as an alternative, with promising results. They now beat the best traditional compressing method (VVC, versatile video coding) even in terms of peak signal-to-noise ratio for single image compression.

### SUMMARY

A novel deep neural network-based coding system for images to be encoded proposes to determine update parameters of a deep neural network model for decoding the encoded image. These parameters are determined by the encoder and provided to the decoder to update the model of the decoder before decoding the image. This provides structural sparsity by fine-tuning only some parameters of the neural decoder.

According to a first aspect of at least one embodiment, a method for encoding an image comprises determining an embedding representative of the input image using a deep neural network based on a first model comprising a set of parameters, determining parameters updates to fine-tune a second model based on the first model, wherein the fine-tuning is based on the input image and a decoded version of the embedding as decoded using a deep neural network based on the second model, and generating encoded data comprising at least an encoding of a quantized embedding and an encoding of a quantized parameters update, wherein the parameters are limited to a selected set of parameters.

According to a second aspect of at least one embodiment, a method for decoding an image comprises obtaining decoded embedding and parameters update from the encoded data, updating parameters of a model of a deep neural network by the obtained parameters update, and determining a decoded image based on the obtained decoded embedding using the deep neural network with the updated parameters.

According to a third aspect of at least one embodiment, an apparatus comprises an encoder for encoding an image, the encoder being configured to determine an embedding representative of the input image using a deep neural network based on a first model comprising a set of parameters, determine parameters updates to fine-tune a second model based on the first model, wherein the fine-tuning is based on the input image and a decoded version of the embedding as decoded using a deep neural network based on the second model, and generate encoded data comprising at least an encoding of a quantized embedding and an encoding of a quantized parameters update, wherein the parameters are limited to a selected set of parameters.

According to a fourth aspect of at least one embodiment, an apparatus comprises a decoder for decoding an image, the decoder being configured to obtain decoded embedding and parameters update from the encoded data, update parameters of a model of a deep neural network by the obtained parameters update, and determine a decoded image based on the obtained decoded embedding using the deep neural network with the updated parameters

According to a fifth aspect of at least one embodiment, a computer program comprising program code instructions executable by a processor is presented, the computer program implementing the steps of a method according to at least the first or second aspect when executed on a processor.

According to a sixth aspect of at least one embodiment, a non-transitory computer readable medium comprising program code instructions executable by a processor is presented, the instructions implementing the steps of a method according to at least the first or second aspect when executed on a processor.

In a variant of first and third aspects, the selected set of parameters is independent from the input image. In a further variant of first and third aspects, the selected set of parameters is selected based on the input image and wherein the encoded data further comprises information representative of the selection. In variants of first and third aspects, the quantization of the parameters update is performed based on a trained quantization with quantization parameters, and wherein the encoded data further comprises information representative of the quantization parameters. In variants of first and third aspects, the fine-tuning is based on a loss function to minimize a measure of a distortion between the input image and an image reconstructed using a deep neural network based on the second model with updated parameters.

In variants of first, second, third and fourth aspects, the parameters are selected among a set comprising a bias, a weight, parameters of a non-linear function of the model, a subset of layers of the model, a specific layer of the model, the bias of a specific layer of the model, and a subset of neurons of the model.

### BRIEF DESCRIPTION OF THE DRAWINGS

FIG. 1 illustrates an example of an example of end-to-end neural network based compression system for encoding an image using a deep neural network.

FIG. 2 illustrates an example of image encoder according to at least one embodiment using identical structural sparsity for any image.

FIG. 3 illustrates an example of image decoder according to at least one embodiment using identical structural sparsity for any image.

FIG. 4 illustrates an example of flowchart for an image encoder according to at least one embodiment using identical structural sparsity for any image.

FIG. 5 illustrates an example of flowchart for image decoder according to at least one embodiment using identical structural sparsity for any image.

FIG. 6 illustrates an example of image encoder according to at least one embodiment using image-specific structural sparsity.

FIG. 7 illustrates an example of image decoder according to at least one embodiment using image-specific structural sparsity.

FIG. 8 illustrates an example of flowchart for an image encoder according to at least one embodiment using image-specific structural sparsity.

FIG. 9 illustrates an example of flowchart for image decoder according to at least one embodiment using image-specific structural sparsity.

FIG. 10 illustrates a block diagram of an example of a system in which various aspects and embodiments are implemented.

FIG. 11 illustrates an example of format for describing the weight update quantization according to at least one embodiment.

FIG. 12 illustrates the impact of the value of the number of last layers to be updated.

FIG. 13 illustrates average performance for different values of k.

FIG. 14 illustrates the performance achieved when using the best value of k for each baseline model M.

FIG. 15 illustrates the PSNR vs bit per pixel of our approach on two different baselines, with six trained models each.

FIG. 16 illustrates the impact of the new training procedure (new loss vs old loss) and of the trainable weight quantization (learnable Q vs non learnable Q), on the 14^{th} image of the test set and with one quality.

### DETAILED DESCRIPTION

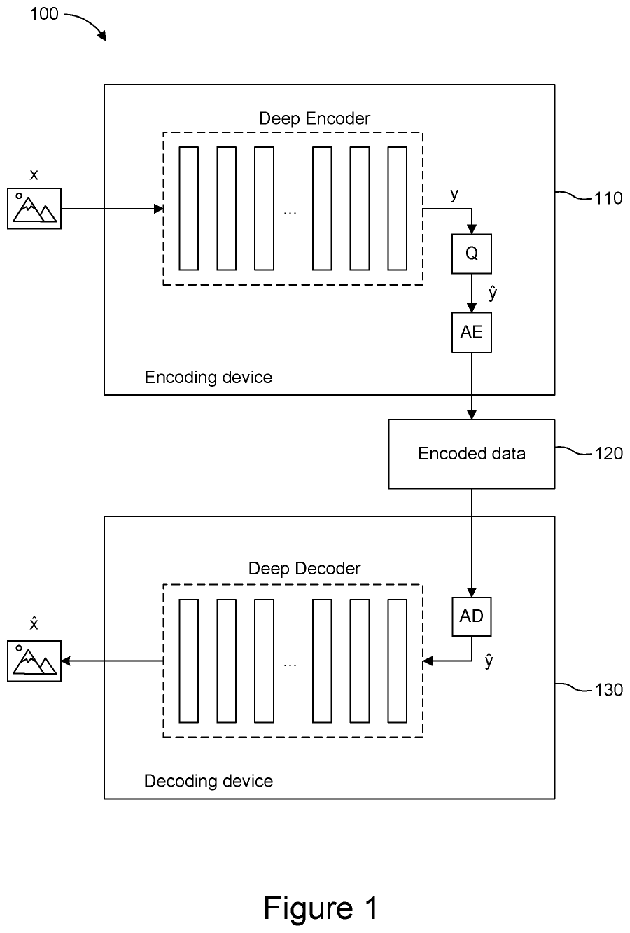

FIG. 1 illustrates an example of end-to-end neural network based compression system for encoding an image using a deep neural network. In such system 100, an input image to be compressed, x, is first processed in an encoding device 110 by a deep neural network encoder (hereafter identified as deep encoder or encoder). The output of the encoder, y, is called the embedding of the image. This embedding is converted into a bitstream 120 by going through a quantizer Q, and then through an arithmetic encoder AE. The resulting bitstream 120 is provided to a decoding device 130 and is decoded by going through an arithmetic decoder AD to reconstruct the quantized embedding ŷ. The reconstructed quantized embedding ŷ is then processed by a deep neural network decoder (hereafter identified as deep decoder or decoder) to obtain the decompressed image \hat{x}.

The deep encoder and decoder are composed of multiple neural layers, such as convolutional layers. Each neural layer can be described as a function that first multiplies the input by a tensor, adds a vector called the bias and then applies a nonlinear function on the resulting values. The characteristics of the tensor and the type of non-linear functions are called the architecture of the network. The values of the tensor and the bias are denoted by the term “weights”. The weights and, if applicable, the parameters of the non-linear functions, are called the parameters of the network. The architecture and the parameters define a “model”. Typically, the encoder and decoder are fixed, based on a predetermined model supposed to be known when encoding and decoding. The layers of the decoder are denoted as l₁, . . . lᵢ, . . . , lₙ and the parameters of the decoder are denoted by θ. The encoder and the decoder models are for example trained simultaneously so that they are compatible. Together, they are sometimes called an “autoencoder”, a model that encodes an input and then reconstructs it. The architecture of the decoder is typically mostly the reverse of the encoder, although some layers or their ordering can be slightly different.

Many end-to-end architectures have been proposed. Typically, they are more complex than the one illustrated in FIG. 1, but they all retain the deep encoder and decoder. State of the art models can compete with traditional video codecs such as Versatile Video Coding (VVC) in terms of rate-distortion tradeoffs.

A model M must be trained on massive databases D of images to learn the weights of the encoder and decoder. Typically, the weights are optimized to minimize a training loss, for example expressed as:

$${L}_{T} ( M , D ) = {E}_{x ∼ D} [ - log ( {p}_{M} ( \hat{y} ) ) + λ d ( x , \hat{x} ) ] ,$$

where p_{M} denotes the probability of the quantized embedding according to M (thus this term is the theoretical lower bound on bitstream size for the encoded quantized embeddings), d(.,.) a measure of the distortion between the original and the reconstructed image (for example the mean square error, Multi-Scale Structural Similarity Index Measure (MS-SSIM), Information Weighted Structural Similarity Index Measure (IWSSIM), Video Multimethod Assessment Fusion (VMAF), Visual Information Fidelity (VIF), Peak Signal to Noise Ratio Human Visual System Modified (PSNR-HVS-M), Normalized Laplacian Pyramid Distance (NLPD) or Feature Similarity Index Measure (FSIM)) and λ a parameter controlling the trade-off between the rate (r) and distortion (d) terms.

Typically, an architecture is trained several times, using different values for λ, to yield a set of models {Mᵢ} with different rate/distortion (r/d) trade-offs. Usually, different architectures yield models with different r/d points. To compare these architectures, the r/d points of each architecture are interpolated, resulting in a function d(r) for each architecture that provides a distortion estimate for any rate value.

The deep decoder as proposed in FIG. 1 can decode any type of image. In other words, it performs well on average for all images, but it is likely to be suboptimal for any single image. It is possible to improve the rate-distortion trade-off for a single video by retraining the decoder specifically for this video and by transmitting weight updates δ for the decoder in addition to the quantized embeddings for intra frames of the video. Before decoding the quantized embedding, δ is added to θ. Such technique is denoted as fine-tuning. The weight updates δ are determined by a fine-tuning algorithm that minimizes a loss function that can for example be:

$${L}_{FT} ( M , δ , x ) = - log ( {p}_{Δ} ( δ ) ) + β d ( x , \hat{x} ( δ ) ) ,$$

where p_{Δ}(.) denotes a probability density over weight updates, \hat{x}(δ) the image reconstructed by the decoder whose weights have been updated by δ and β a trade-off between the two losses.

However, this approach does not achieve rate distortion improvements for single images because of the increased code size due to the inclusion of the weights updates. In an example implementation, an additional term may be added to the loss to enforce a global sparsity constraint on δ, so that a lot of weight updates have the same value (0), to make encoding more efficient.

The current approach of fine-tuning the decoder with a global sparsity constraint leads to an improved performance in terms of rate-distortion for encoding a video. However, this approach is not suitable for single images because of the increased code size due to the inclusion of the weight updates, even with the global sparsity constraint. Furthermore, fine tuning the decoder requires optimizing the value of β. This might cause several fine-tunings of the decoder, an expensive procedure.

Embodiments described hereafter have been designed with the foregoing in mind and are based on enforcing structural sparsity of a deep neural network used in an image compression system, in other words, fine-tuning only some parameters of the neural decoder, thus reducing the number of updates that need to be encoded. This results in a better coding efficiency even for single images thanks to a reduction of the amount of data representing the encoded image. The principle applies also to an image (i.e., frame) of a video sequence.

In embodiments, a deep neural network based coding system for images determines selected update parameters of a deep neural network model for an image to be encoded. These parameters are provided to the decoder to update the model of the decoder before decoding the image. This provides structural sparsity by fine-tuning only a selected subset of parameters of the neural decoder. In this context, fine-tuning refers to a training algorithm that is adapted to train, on a small set of data points, a machine learning model that was already trained on a typically much larger data set. In this particular case, the decoder (previously trained on a large data set) is fine-tuned for a single image (the small data set). Fine-tuning is for example performed by minimizing a loss function. In at least one embodiment, the update of the model is done on a selected set of parameters independently of the image to be encoded, for example the bias of the last five convolutional layers of the model. In such embodiment, the structural sparsity is identical for all images. In at least one embodiment, the set of parameters to update the model is selected based on the image to be encoded. In such embodiment, the structural sparsity is image specific.

At least one embodiment proposes to use a training procedure for fine-tuning an end-to-end decoder that avoids optimizing hyperparameters and guarantees a better r/d performance by explicitly maximizing bitrate saving.

At least one embodiment proposes an application of trainable quantization to weight updates in an end-to-end decoder fine-tuning and the inclusion of these trained parameters in the bitstream, leading to improved performance.

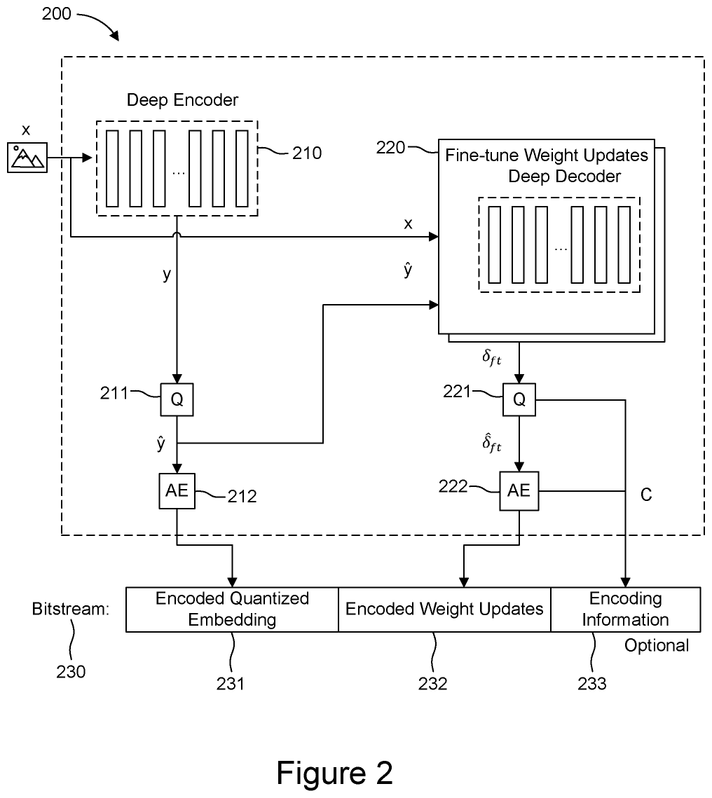

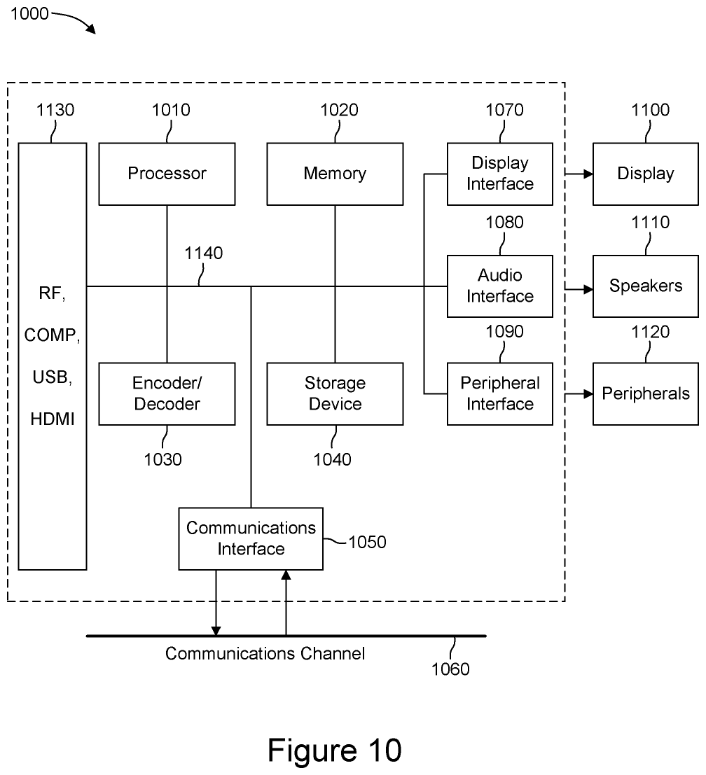

FIG. 2 illustrates an example of image encoder according to at least one embodiment using identical structural sparsity for any image. Such encoder 200 is for example implemented in the device 1000 of FIG. 10. In this embodiment, the structural sparsity is enforced by fine-tuning only a limited set of selected parameters θ_{ft}⊂θ of the decoder. θ_{ft} is identical for all images; in other words, the same subset of parameters is fine-tuned for all images. For example, this limited set may comprise the bias and/or the weights and/or the parameters of the non-linear functions and/or any other parameter of the decoder and/or any subset of these elements. Such a subset may for example be defined as a subset of the layers, such as the last k layers, or the bias of the last k layers, or a subset of the neurons. In at least one embodiment, the set of selected parameters θ_{ft} is predetermined. The description below and the figures use the example of weight update, but the same principles apply to the other parameters of the model.

An input image x in first encoded using the deep encoder 210, to obtain an embedding y. This embedding is then quantized for example by a quantizer 211 and encoded for example by an arithmetic encoder 212 or another encoder, resulting in the encoded quantized embedding 231.

The weight updates are optimized by a fine-tuning algorithm 220, based on the input image x and the quantized embedding ŷ. The fine-tuning algorithm iterates on different updates δ_{ft} for the selected parameters θ_{ft} to jointly minimize a measure of the distortion between the original and the reconstructed image (with updated parameters) and the code length of these updates. For that purpose, the fine-tuning loss function can be for example:

$${L}_{FT} ( M , {δ}_{ft} , x ) = - log ( {p}_{Δ} ( {δ}_{f t} ) ) + β d ( x , \hat{x} ( {δ}_{ft} ) ) ,$$

image \hat{x} being the image as decoded with an updated decoder using the updated fine-tuning parameters δ_{ft} for the selected parameters θ_{ft}.

The loss may also contain additional terms, for example a term inducing a constraint on the weights such as a sparsity constraint.

These weight updates might then be quantized, for example by a quantizer 221. We denote these quantized weight updates by \hat{δ}_{ft}. Finally, the weight updates \hat{δ}_{ft} are encoded for example using an arithmetic encoder 222 or another encoder.

The encoded data is then aggregated together, for example in the form of a bitstream, and comprises at least the quantized embedding ŷ 231 and the weight updates \hat{δ}_{ft} 232 for example encoded by an arithmetic encoder or another encoder.

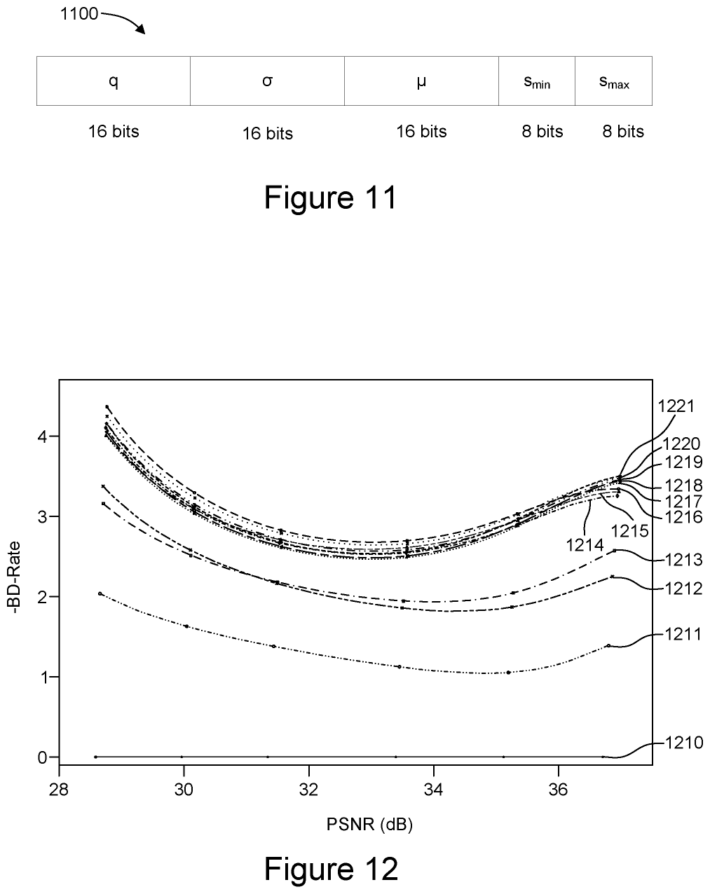

The quantization and encoding of the weight updates depend on parameters that might either be the same for all images or some/all could be fine-tuned for each image. In the latter case, the encoded data also include the values of these parameters 233, denoted by C in the figure. FIG. 11 proposes an example of format for carrying C and discussed the underlying principles.

The person skilled in the art will understand that these elements 231, 232, 233 may be arranged in any order or even interleaved in a bitstream.

In a variant of this embodiment, the quantized embedding ŷ can be fine-tuned jointly with \hat{δ}_{ft}. In that case, the bitstream remains the same but the loss may be:

$${L}_{FT} ( M , {δ}_{ft} , x ) = - log ( {p}_{Δ} ( {δ}_{ft} ) ) - log ( {p}_{M} ( \hat{y} ) ) + β d ( x , \hat{x} ( {δ}_{ft} ) ) .$$

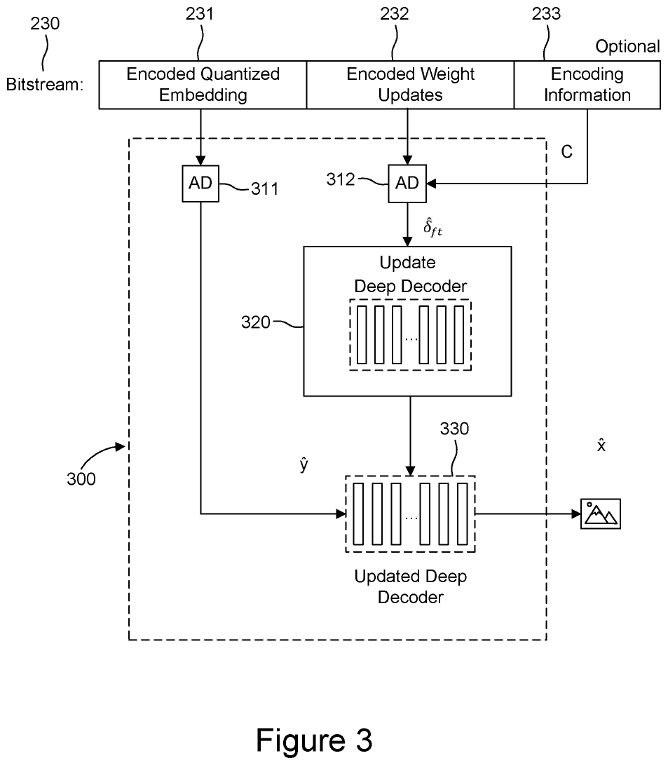

FIG. 3 illustrates an example of image decoder according to at least one embodiment using identical structural sparsity for any image. This decoder 300 is for example implemented in the device 1000 of FIG. 10 and is adapted to decode data encoded by the encoder 200 of FIG. 2, for example arranged as a bitstream 230, comprising encoded quantized embedding 231, weight updates 232 and optionally encoding information C 233. If present, the encoding information C 233 is extracted from the bitstream. The quantized embeddings are decoded, for example by an arithmetic decoder 311, into ŷ and the quantized weight updates are decoded, for example by an arithmetic 312, into δ_{ft} (optionally based on the encoding information C). Then the deep decoder 320 is updated based on the quantized weight updates. Finally, the image \hat{x} is decoded from the quantized embeddings ŷ by the updated deep decoder 330, in other words the deep decoder for which a selected subset of the parameters (for example weights) have been updated according to δ_{ft}.

The figure represents a system where invertible operations related to quantization of the weight updates are also inverted in the AD block 312. The same system could be described using an additional block (placed between 312 and 320) called for example “dequantization” or “inverse quantization” to perform these operations. An example of such an invertible operation is the scaling of the weight updates prior to quantization, to change the quantization resolution.

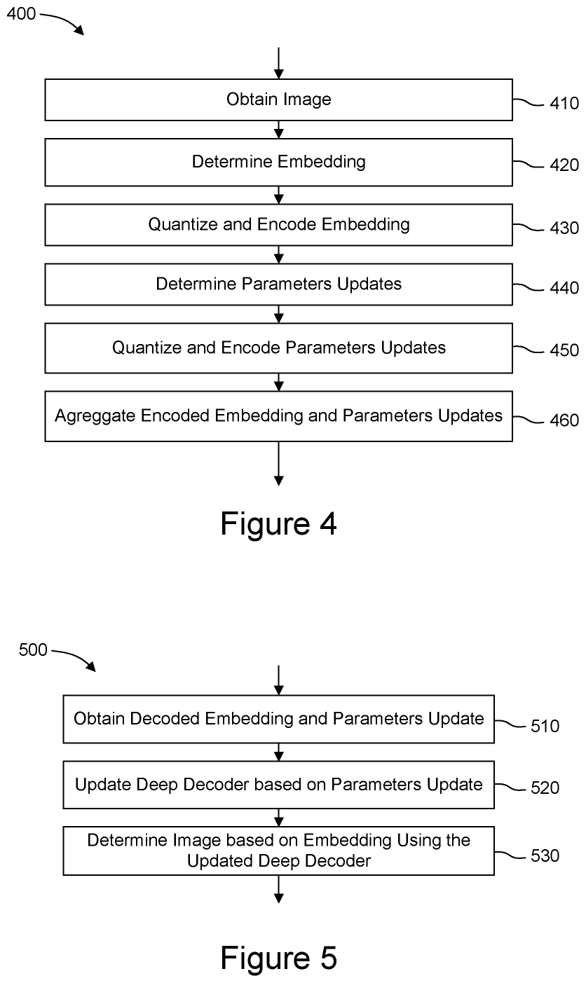

FIG. 4 illustrates an example of flowchart for an image encoder according to at least one embodiment using identical structural sparsity for any image. This flowchart is operated by the encoder 200 of FIG. 2 and for example implemented in the device 1000 of FIG. 10. In step 410, the device obtains an input image. In step 420, the device determines the corresponding embedding by using the deep encoder. In step 430, the embedding is quantized and encoded. In step 440, the device determines parameter updates for a selected subset of parameters of the deep decoder, such as described above in relation with FIG. 3. In step 450, the parameter updates are quantized and encoded. In step 460, the encoded data—comprising at least the quantized encoded embedding and the quantized and encoded parameter updates—is aggregated for example into a bitstream adapted to be provided to another device or to be stored on a storage medium.

As described above, the parameters for the update may comprise the bias and/or the weights and/or the parameters of the non-linear functions and/or any other parameter of the decoder and/or any subset of these elements and may be defined as a subset of the layers, for example the last k layers.

Optionally, encoding information is determined and encoded in order to be embedded into the encoded data with the other data.

FIG. 5 illustrates an example of flowchart for image decoder according to at least one embodiment using identical structural sparsity for any image. This flowchart is operated by the decoder 300 of FIG. 3 and for example implemented in the device 1000 of FIG. 10. In step 510, the device obtains encoded data aggregated together for example into a bitstream received from another device or read from a storage medium and decodes the encoded data. The encoded data comprises at least the quantized encoded embedding and the quantized and encoded parameter update. As a result of the decoding, the decoded data comprises at least the quantized embedding and the parameter update. In step 520, the device updates the deep decoder by updating the values of a selected subset of parameters based on the parameter update. In step 530, the device determines the image from the embedding and the updated deep decoder. Thanks to the update, the difference between the original input image and the decoded image is reduced compared to what it would be if decoded with a non-updated decoder.

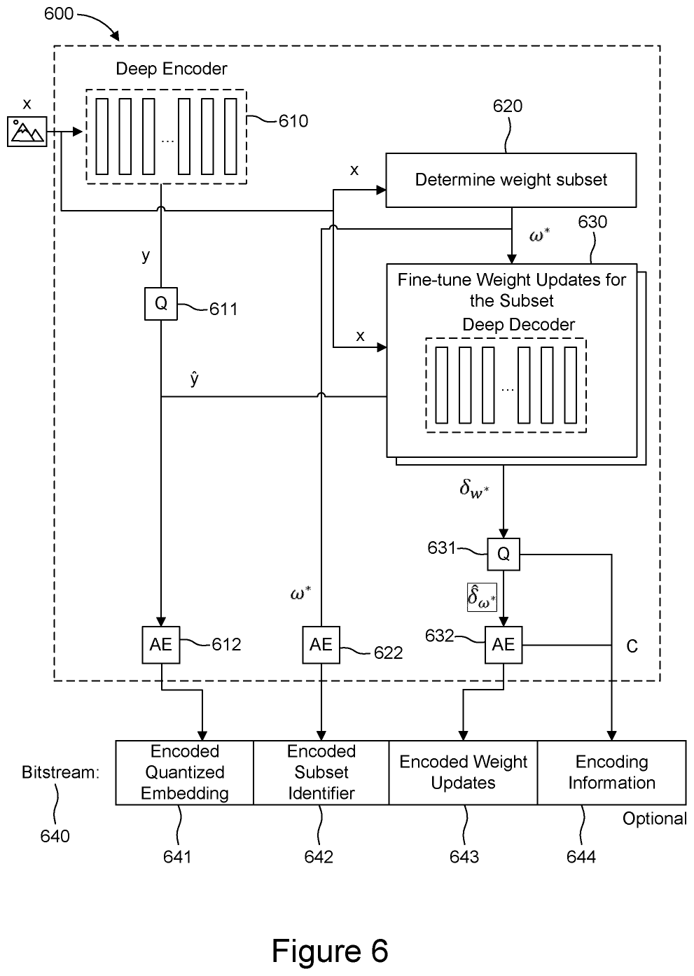

FIG. 6 illustrates an example of image encoder according to at least one embodiment using image-specific structural sparsity. Such encoder 600 is for example implemented in the device 1000 of FIG. 10. While fine-tuning a fixed subset of parameters θ_{ft} as described above improves the rate-distortion tradeoff for single images, this specific structural sparsity constraint might not be optimal for every image. In this embodiment, an image-specific structural sparsity constraint is used. In other words, the subset of parameters to be fine-tuned may be different for each image and the subset of parameters is selected based on the input image to be encoded.

However, allowing the fine-tuning algorithm to choose any subset of parameters might be counterproductive. Indeed, in that case, the bitstream must also contain information identifying this subset. As an example, one could include this information by including the indexes of the weights that are optimized. This would significantly increase the bitstream size and lead to a worse rate-distortion tradeoff.

Therefore, in this embodiment, the fine-tuning algorithm freedom in optimizing θ_{ft} for each image is limited to a subset of parameters. Let θ₁, . . . , θₘ⊂θ denote a set of non-overlapping subsets of θ and let δ₁, . . . , δₘ denote associated parameter updates. For each image x, the fine-tuning algorithm can fine-tune any combination of the parameters θ₁, . . . , θₘ. The fine-tuning algorithm thus tries to solve the following combinatorial optimization problem to select the subset of weights to be fine-tuned:

$${ω}^{*} = arg {max}_{ω ∈ Ω} {L}_{FT} ( M , {δ}_{ω} , x ) ,$$

where Ω denotes the set of all combinations of θ₁, . . . , θₘ. The updates δ_{ω*} of the weights in ω* are then computed as in the previous section.

The input image x in first encoded using the deep encoder 610, to obtain the embedding y. This embedding is then quantized, for example by a quantizer 611 and encoded, for example by an arithmetic encoder 612 or another encoder, resulting in the encoded quantized embedding 641.

A selection block 620 selects the weight subset ω* to be optimized according to the combinatorial optimization problem described above. The weight subset ω* may be represented using different techniques. For example, the subset may be represented by the index of ω* in Ω or by the set of indexes of the θ₁, . . . , θₘ included in ω*. The parameters corresponding to the selected subset ω* are then optimized by the fine-tuning algorithm 630, based on the input image and the quantized embedding ŷ, resulting in the weight updates δ_{ω*}. The fine-tuning uses the same mechanism as described previously for the encoder 200 of FIG. 2, with the difference that the set of parameters has been previously selected by the selection block 620. Note that these two steps could happen at the same time, i.e., performing both optimizations at the same time.

These weight updates δ_{ω*} are also quantized, for example by a quantizer 631. The result is denoted by \hat{δ}_{ω*}. The selection of the weights is then encoded, for example by an arithmetic encoder 622 as well as the quantized weight updates, for example by an arithmetic encoder 632. These elements may be encoded by an arithmetic encoder or another type of encoder.

The encoded data is then aggregated, for example in the form of a bitstream 640, and comprises at least the quantized embedding ŷ 641, the weight subset ω* 642 and the weight updates \hat{δ}_{ω*} 643.

Quantizing and encoding δ_{w*} may optionally involve parameters optimized for each image. In this case, encoded data also includes encoding information 644 (denoted by C) representing the values of these parameters.

As in the previous section with reference to FIGS. 2, 3, 4 and 5, these elements may be arranged in any order or even interleaved in the bitstream and the quantized embeddings ŷ can be fine-tuned jointly with δ_{ω*}.

As an example, each subset θⱼ could be defined as the biases of layer lⱼ of the decoder. In that case, Ω is the combinations of all integers 1, . . . , n. The identifier of ω* could be the indexes of the layers whose biases have been fine-tuned.

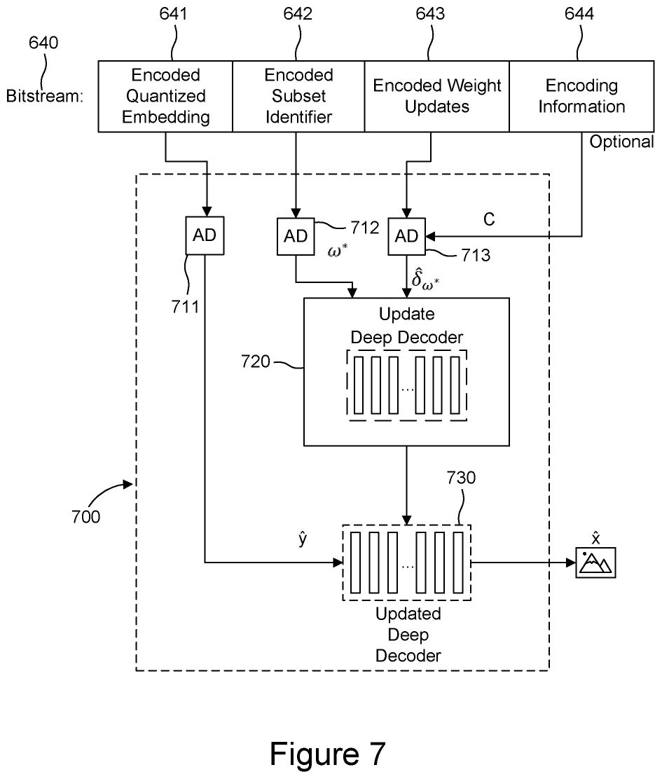

FIG. 7 illustrates an example of image decoder according to at least one embodiment using image-specific structural sparsity. Such decoder 700 is for example implemented in the device 1000 of FIG. 10 and is adapted to decode data encoded by the encoder 600 of FIG. 7, for example arranged as a bitstream 640, and comprises at least the quantized embedding ŷ 641, weight subset ω*, the weight updates \hat{δ}_{ω*} 643 and optionally the encoding information C 644.

The quantized embeddings are decoded into ŷ, for example by an arithmetic decoder 711. The weight subset ω* is decoded, for example by an arithmetic decoder 712 and the quantized weight updates are decoded into \hat{δ}_{ω*} (optionally based on the encoding information C 644 is present in the encoded data) for example by an arithmetic decoder 713. This information allows to perform an update 720 of the decoder, based on the weight subset ω* and the quantized weight updates \hat{δ}_{ω*}. Then the image \hat{x} is decoded from the quantized embeddings ŷ by the updated deep decoder 730; in other words, the deep decoder for which some of the parameters have been updated according to \hat{δ}_{ω*}.

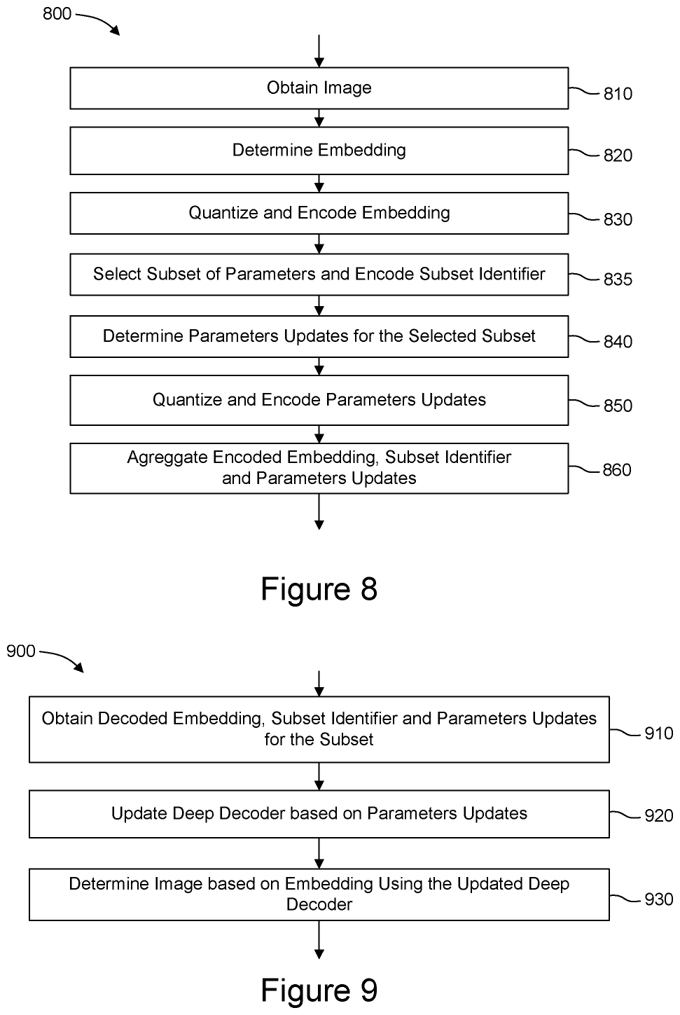

FIG. 8 illustrates an example of flowchart for an image encoder according to at least one embodiment using image-specific structural sparsity. This flowchart is operated by the encoder 600 of FIG. 6 and for example implemented in the device 1000 of FIG. 10.

In step 810, the device obtains an input image. In step 820, the device determines the corresponding embedding by using the deep encoder. In step 830, the embedding is quantized and encoded. In step 835, the device determines a selected subset of parameters according to the input image. In step 840, the device determines parameter updates for the selected subset of parameters of the deep decoder, such as described above in relation with FIG. 6. In step 850, the parameter updates are quantized and encoded. In step 860, the encoded data—comprising at least the quantized encoded embedding, an encoded information representative of the selected subset of parameters and the quantized and encoded parameter update—is aggregated for example into a bitstream adapted to be provided to another device or to be stored on a storage medium.

As described above, the parameters for the update may comprise the bias and/or the weights and/or the parameters of the non-linear functions and/or any other parameter of the decoder and/or any subset of these elements and may be defined as a subset of the layers, for example the last k layers.

Optionally, encoding information is determined and encoded in order to be embedded into the encoded data with the other data.

In addition to the encoding and decoding methods and devices described above, at least one embodiment relates to a new training procedure for fine tuning the decoder. The key part of this training procedure is the use of a new fine-tuning loss that does not involve optimizing the hyperparameter β. Rather than optimizing the rate distortion tradeoff directly, it is proposed to use a loss that forces the fine-tuned algorithm to improve over the baseline model Mₒ. This loss can be used for any decoder fine-tuning algorithm that optimizes a set of weight updates δ, including the embodiments discussed above.

More specifically, this training procedure will minimize the ratio

$$\frac{{r}_{ft}}{{r}_{o}}$$

between the two rates: the rate of the fine-tuned model, r_{ft} and the rate of the original architecture, rₒ, at the distortion d_{ft} achieved by the fine-tuned model. In other words, the following loss is proposed:

$${L}_{FT , new} = \frac{{r}_{ft} ( {d}_{ft} )}{{r}_{o} ( {d}_{ft} )} .$$

Unfortunately, as discussed above, the rate of the original architecture is not available for every distortion. However, the function dₒ(r) can be inverted to obtain a rate estimation function for the original architecture, rₒ(d).

So that loss becomes:

$${L}_{FT , new} = \frac{{r}_{ft} ( {d}_{ft} )}{{r}_{o} ( {d}_{ft} )} = \frac{{r}_{o} ( d ( x , \hat{x} ) ) - log {p}_{Δ} ( {δ}_{ft} ) + len ( C )}{{r}_{o} ( d ( x , \hat{x} ( {δ}_{ft} ) ) )} .$$

The denominator is the estimated rate of the original architecture, at the distortion value of the image reconstructed by the fine-tuned encoder. The numerator is the actual rate of the fine-tuned decoder. The first term is the rate rₒ(d(x, \hat{x})) of the model M used as a baseline for fine-tuning. It corresponds to the encoding of the quantized embeddings. Hence, rₒ(d(x, \hat{x}))=−log(p_{M}(ŷ)). The second term, −log p_{Δ}(δ_{ft}), correspond to the encoding of the weight updates and len(C) to the size of the characteristics of the weight update quantizer and encoded that need to be transmitted.

This loss is advantageous because it does not contain any hyperparameter such as β that must be optimized. Therefore, it speeds up the fine-tuning process. The downside is that it requires the function rₒ(d), so at least two trained models from the original architecture. This is typically not a problem, as multiple models are trained for different operating points.

As an example, the estimated rate rₒ(d(x, \hat{x}(δ_{ft}))) can be approximated using a linear interpolation between the baseline model Mₒ and a model Mₚ from the same set of models {Mᵢ} than Mₒ but with a different r/d trade-off (for example, Mₚ is the model with the closest rate to Mₒ, or the model with the next higher quality). In this case:

$${r}_{o} ( d ( x , \hat{x} ( {δ}_{ft} ) ) ) = {r}_{o} ( d ( x , \hat{x} ) ) + ( d ( x , \hat{x} ( {δ}_{ft} ) ) - d ( x , \hat{x} ) ) \times \frac{{r}_{p} ( d ( x , \hat{x} ( {M}_{p} ) ) ) - {r}_{0} ( d ( x , \hat{x} ) )}{d ( x , \hat{x} ( {M}_{p} ) ) - d ( x , \hat{x} )}$$

where \hat{x}(Mₚ) denotes the image encoded/decoded by model Mₚ. \hat{x}=\hat{x}(Mₒ)

Any interpolation method can be used, for example polynomial interpolation of any order or approximation by a machine learning model.

FIG. 9 illustrates an example of flowchart for image decoder according to at least one embodiment using image-specific structural sparsity. This flowchart is operated by the decoder 700 of FIG. 7 and for example implemented in the device 1000 of FIG. 10.

In step 910, the device obtains encoded data aggregated together for example into a bitstream received from another device or read from a storage medium and decodes the encoded data. As a result of the decoding, the decoded data comprises at least the quantized embedding, an information representative of the selected subset of parameters and the quantized parameters update. In step 920, the device updates the deep decoder by selecting a set of parameters of the deep decoder based on the information representative of the selected subset of parameters and updating the values of the selected parameters based on the parameters update, resulting in an updated deep decoder. In step 930, the device determines the image from the received embedding and the updated deep decoder.

FIG. 10 illustrates a block diagram of an example of a system in which various aspects and embodiments are implemented. System 1000 can be embodied as a device including the various components described below and may be configured to perform one or more of the aspects described in this application such as the encoder 200 of FIG. 2, the decoder 300 of FIG. 3, the encoder 600 of FIG. 6 or the decoder 700 of FIG. 7. Examples of such devices include, but are not limited to, various electronic devices such as personal computers, laptop computers, smartphones, tablet computers, digital multimedia set top boxes, digital television receivers, personal video recording systems, connected home appliances, encoders, transcoders, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video, or portions of the decoded video, the bitstream, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements necessary for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the data stream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a Wi-Fi network such as IEEE 802.11. The Wi-Fi signal of these embodiments is received over the communications channel 1060 and the communications interface 1050 which are adapted for Wi-Fi communications. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs. The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

FIG. 11 illustrates an example of format for describing the weight update quantization according to at least one embodiment. Many existing quantization and encoding techniques may be used to quantize and encode the weight updates δ_{ft} of size u. The following approach illustrates what C could be.

It is proposed to use uniform scalar quantization over scaled bias updates in the test phase. Quantization is performed by rounding the scaled inputs to the nearest integer value by Q(δ_{ft}, q)=round(δ_{ft}·q), where ‘·’ denotes multiplication of a vector by a scalar. Since the value of q is learned for each image, it can be used to adjust the quantization resolution. Dequantization cancels the scaling: Q⁻¹∘Q(δ_{ft}, q)=round(δ_{ft}·q)/q. However, since the rounding operator has non-informative gradients, it cannot be used in training phase. For training, this rounding operator is relaxed using the standard technique of additive uniform noise. Thus, in training phase, we apply quantization and dequantization as follows:

$${Q}_{T} ( {δ}_{ft} , q ) = {δ}_{ft} \cdot q + ϵ$$

$${Q}_{T}^{- 1} ∘ {Q}_{T} ( {δ}_{ft} , q ) = {δ}_{ft} + ϵ / q ,$$

where ϵ∈R^{u} is iid (independent, identically distributed) uniform noise where ϵᵢ˜U(−0.5,0.5). If the quantization scale q is learned for each image, we should include q into the bitstream as part of C, using 16 bits.

Surprisingly, the bias updates often follow a gaussian distribution. Since we quantize the scaled updates to the nearest integer value, the bin width of the quantization is 1. Thus, expected probability of the given scaled and quantized update vector \hat{δ}_{ft} can be calculated during fine tuning as follows:

$$p ( {\hat{δ}}_{ft} ) = {\prod }_{i} {\int }_{{\hat{δ}}_{ft} [ i ] - 0.5}^{{\hat{δ}}_{ft} [ i ] + 0.5} N ( x ; μ , σ ) . dx$$

Where \hat{δ}_{ft}[i] is the i^{th} element of vector \hat{δ}_{ft}, N(.; μ, σ) is the probability density function of gaussian distribution parameterized by μ, σ which are mean and standard deviation of vector \hat{δ}_{ft} as they are the closed form solution of gaussian probability model fitting on given vector \hat{δ}_{ft}. In test phase, to compress the bias's updates with entropy coding, the truncated gaussian distribution is fit on quantized scaled bias's updates whose support is defined by minimum symbol sₘᵢₙ to maximum symbol sₘₐₓ. If these parameters are trained for each image, C must include fitted truncated gaussian parameter μ, σ using 16-bits for each and sₘᵢₙ, sₘₐₓ using 8-bits for each parameter in addition to 16-bits encoded quantization's scale parameter q. This 64-bit long information are the updates encoding information that we need to add to the bitstream whose bit-length was shown by len(C) in loss function. The proposed format 1100 of the figure illustrates one possibility for a bitstream encoding C in this specific example.

The following figures illustrate typical experimental results of the present principles on the Kodak Test Set. The neural network architecture used is the cheng2020-anchor architecture as described in Z. Cheng, H. Sun, M. Takeuchi, and J. Katto, “Learned image compression with discretized gaussian mixture likelihoods and attention modules,” in CVPR, 2020. Six different trained models M are used as baselines. Different subsets of parameters are fined-tuned and evaluated: the bias of the last k convolutional layers of each model M, where k is allowed to vary. Unless specified otherwise, the new training loss and trainable weight quantization are used, and results are an average over all images in the test set.

FIG. 12 illustrates the impact of the value of the number of last layers to be updated. More particularly, it shows the impact of k for values from 1 to 10 in terms of BD rate gain (of our approach and with respect to a baseline M) as a function of the PSNR. Each data point corresponds to a baseline model M. Average values of k, e.g., k=5, are optimal in this case, with lower values significantly worse. The baseline is represented by the line 1210. Curves 1211 to 1221 represented increasing values of k, respectively from 1 to 11.

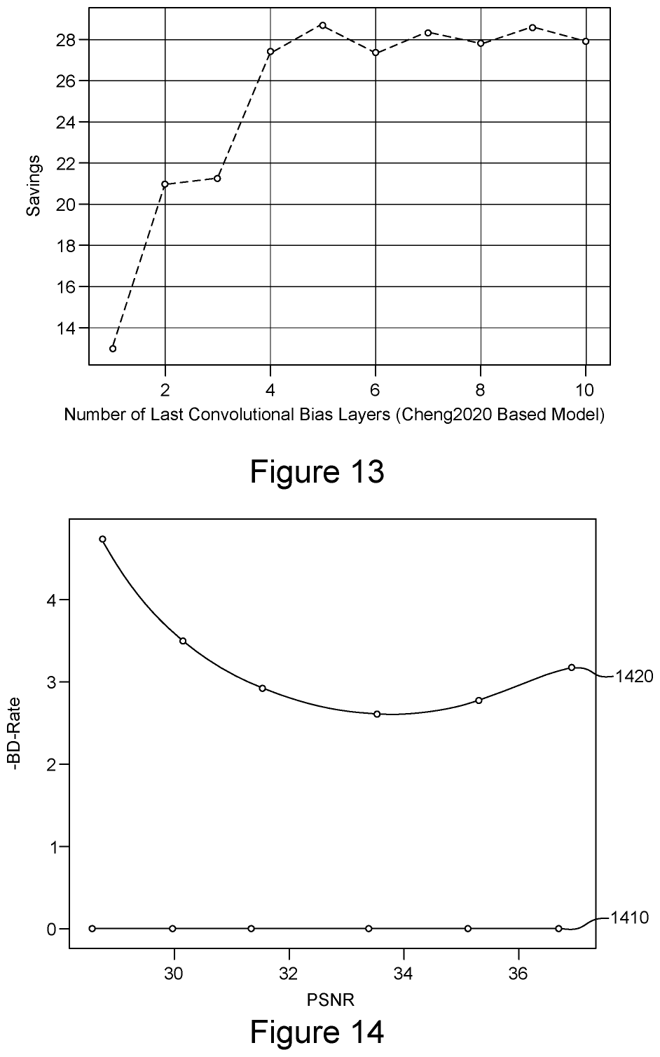

FIG. 13 illustrates average performance for different values of k. It summarizes the results of FIG. 12. For each value of k (x axis), it displays the value of the area under of the curve of that value in FIG. 12. This corresponds to the average performance of each value of k from 1 to 10 over all baseline models M. In other words, the curve represents the savings with regards to the baseline according to an increasing number of last convolutional bias layers.

FIG. 14 illustrates the performance achieved when using the best value of k for each baseline model M. This better showcases the performance that could be achieved in practice, where the number of layers can be chosen independently for each baseline model M. The baseline is represented by the line 1410. The curve 1420 represents the proposed solution.

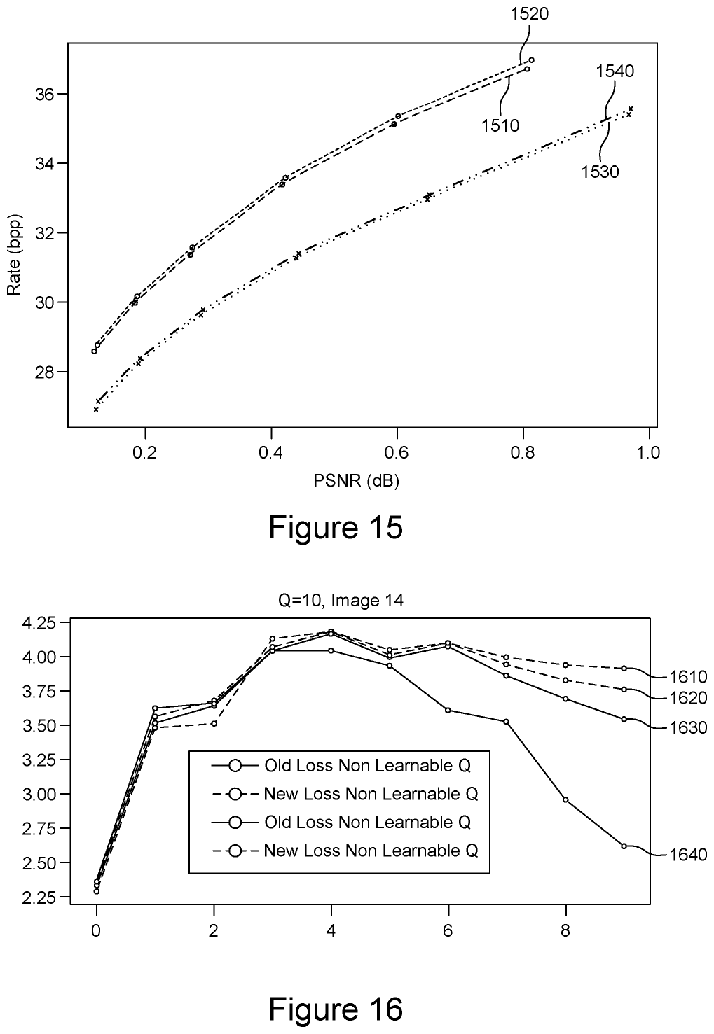

FIG. 15 illustrates the PSNR vs bit per pixel of our approach on two different baselines, with six trained models each. Curve 1510 represents a baseline based on the cheng2020-anchor architecture and curve 1520 represents the application of the proposed approach to this baseline. Curve 1530 represents a baseline based on the bmshj2018_factorized architecture as described in J. Ballé, D. Minnen, S. Singh, S. J. Hwang, and N. Johnston, “Variational image compression with a scale hyperprior,” in 6th International Conference on Learning Representations, ICLR 2018, Vancouver, BC, Canada, April 30-May 3, 2018, Conference Track Proceedings, 2018. The curve 1540 represents the application of the proposed approach to this second baseline. For the proposed solution, only the best value of k is displayed. Other values of k would lie between the proposed solution and the corresponding baseline.

FIG. 16 illustrates the impact of the new training procedure (new loss vs old loss) and of the trainable weight quantization (learnable Q vs non-learnable Q), on the 14^{th} image of the test set and with one selected quality. This quality and image were chosen as the most representative of the results and the values correspond to BDrate gain with respect to the baseline for different values of k. Curve 1610 represents the old loss for non-learnable quantization, curve 1620 represents the new loss for non-learnable quantization, curve 1630 represents the old loss for learnable quantization, and curve 1640 represents the new loss for learnable quantization. The combination of the new loss and trainable quantization consistently achieve best or close to best results for high values of k (x axis) but lead to slightly worse results for k<4.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for encoding an input image, the method comprising:
determining, using a deep neural network based on a first model, an embedding representative of the input image;
selecting a subset of parameters to be updated based on the input image;
determining a parameter update for the selected subset of parameters for fine-tuning a second neural network model based on the first model, wherein the fine-tuning is based on the input image and a decoded version of the embedding as decoded using a deep neural network based on the second neural network model; and
generating encoded data comprising at least an encoded quantized embedding, information representative of the selected subset of parameters and an encoded quantized parameter update.

2-3. (canceled)

4. The method of claim 1, further comprising quantizing the parameters update based on a trained quantization with one or more quantization parameters, and wherein the encoded data further comprises information representative of the one or more quantization parameters.

5. The method of claim 1, wherein the fine-tuning is based on a loss function to minimize a measure of a distortion between the input image and an image reconstructed using a deep neural network based on the second neural network model updated with one or more updated parameters.

6. The method of claim 1, wherein the selected subset of parameters is selected from among a set comprising a bias, a weight, one or more parameters of a non-linear function of a model, a subset of layers of the model, a specific layer of the model, a bias of a specific layer of the model, and a subset of neurons of the model.

7. A method for decoding an image represented by encoded data, the method comprising:
obtaining a decoded embedding, information representative of a selected subset of parameters of a model of a deep neural network and a decoded parameters update from the encoded data;
selecting the selected subset of parameters based on the information;
updating the selected subset based the decoded parameters update; and
determining, using the deep neural network with the updated parameters, a decoded image based on the obtained decoded embedding.

8. The method of claim 7, wherein the selected subset of parameters is comprised in a set comprising a bias, a weight, one or more parameters of a non-linear function of the model, a subset of layers of the model, a specific layer of the model, a bias of a specific layer of the model, and a subset of neurons of the model.

9. An apparatus, comprising an encoder for encoding an input image, the encoder being configured to:
determine, using a deep neural network based on a first model, an embedding representative of the input image;
select a subset of parameters to be updated based on the input image;
determine a parameter update for the selected subset of parameters for fine-tuning a second neural network model based on the first model, wherein the fine-tuning is based on the input image and a decoded version of the embedding as decoded using a deep neural network based on the second neural network model; and
generate encoded data comprising at least an encoded quantized embedding, information representative of the selected subset of parameters and an encoded quantized parameter update.

10-11. (canceled)

12. The apparatus of claim 9, further comprising quantizing the parameters update based on a trained quantization with one or more quantization parameters, and wherein the encoded data further comprises information representative of the one or more quantization parameters.

13. The apparatus of claim 9, wherein the fine-tuning is based on a loss function to minimize a measure of a distortion between the input image and an image reconstructed using a deep neural network based on the second neural network model updated with one or more updated parameters.

14. The apparatus of claim 9, wherein the selected subset of parameters is selected from among a set comprising a bias, a weight, one or more parameters of a non-linear function of a model, a subset of layers of the model, a specific layer of the model, a bias of a specific layer of the model, and a subset of neurons of the model.

15. An apparatus, comprising a decoder for decoding an image represented by encoded data, the decoder being configured to:
obtain a decoded embedding, information representative of a selected subset of parameters of a model of a deep neural network and a decoded parameters update from the encoded data;
select a subset of parameters based on the information;
update the selected subset based on the decoded parameters update; and
determine, using the deep neural network with updated parameters, a decoded image based on the obtained decoded embedding.

16. The apparatus of claim 15, wherein the selected subset of parameters is comprised in a set comprising a bias, a weight, one or more parameters of a non-linear function of the model, a subset of layers of the model, a specific layer of the model, a bias of a specific layer of the model, and a subset of neurons of the model.

17. (canceled)

18. A non-transitory computer readable medium comprising program code instructions for implementing the method according to claim 1 when executed by a processor.

19. A non-transitory computer readable medium comprising program code instructions for implementing the method according to claim 7 when executed by a processor.
